(19) United States
(12) Patent Application Publication
(10) Pub. No.: US 2022/0042600 A1
(43) Pub. Date: Feb. 10, 2022

(54) GLASS REINFORCED EPOXY KAMMPROFILE SEALING GASKET

(71) Applicant: LGC US Asset Holdings, LLC, Houston, TX (US)

(72) Inventors: Benjamin Daniel Kramer, Littleton, CO (US); Benjamin Lewis, Lakewood, CO (US); Donald White, Los Angeles, CA (US); Simonas Lukosius, Denver, CO (US)

(21) Appl. No.: 17/305,378

(22) Filed: Jul. 6, 2021

Related U.S. Application Data
(60) Provisional application No. 63/048,527, filed on Jul. 6, 2020.

(51) Int. Cl. F16J 15/10

(52) U.S. Cl. CPC F16J 15/102; F16J 15/104

(57) ABSTRACT

A non-metallic gasket for flanged connections that is capable of achieving the necessary gasket stress to maintain a leak-free seal between the two flanges especially in applications when metallic gaskets cannot be used. The gasket may utilize glass reinforced epoxy, or rigid non-metallic material, as the gasket core. The core receives a kammprofile set of serrations machined into both faces. On top of the serrations a sealing element of varying material is adhered.

CITATION TO PRIOR APPLICATIONS

The present application is a continuation of and claims priority to U.S. Provisional Application No. 63/048527, titled “GLASS REINFORCED EPOXY KAMMPROFILE SEALING GASKET” and filed Jul. 6, 2020.

### BACKGROUND OF THE INVENTION

Traditionally, there are a multitude of gasketed applications where the bolt load of the bolted connection is not sufficient to gain the required gasket stress needed to maintain a proper seal. Such gaskets as compressed sheet gaskets, so-called in-dine plane or quad seal gaskets, and other styles have tried to solve this issue but to-date have been unsuccessful. Common instances where this is a problem is low pressure water meters, epoxy lined flanges, ductile iron flanges, and stainless steel flanges.

Kammprofile gasket design has been used on metal gaskets with success, however, there are a number of instances in which use of a metal gasket is not ideal or not possible due to many varying issues. Accordingly, a metal kammprofile gasket would not be effective. Additionally, it has been a conventional belief in the gasket industry that available non-metallic gasket core materials would not be strong enough to withstand kammprofile machining and the subsequent loads resulting from the machined gasket surface geometry.

Glass reinforced epoxy (GRE) gaskets have sometimes been used as an alternative to metal gaskets where metal gaskets would themselves be ineffective. However, all current GRE gaskets on the market utilize “quad seal” or “incline plane” elastomeric seals. This sealing style is very effective so long as the minimum gasket stress can be achieved. However, the minimum gasket seating stress for this style seal is higher than what is achievable in many cases. These types of seals also require very uniform and even load, which is also not often accomplished with such flanged connections as water meters, ductile iron, and epoxy coated.

Conventional approaches using soft compressed sheet gaskets still require substantial load to adequately seal and often resulted in leaks due to pressure and or temperature cycles which cause the material to creep and relax thus leading to bolt load loss and leaks.

Again, while metal gaskets are also conventionally known for having better sealing properties than the soft compressed sheet, metal gaskets require much higher bolt loads which cannot be achieved in many of these problematic cases. Metal gaskets also introduce potential galvanic corrosion cells onto the pipeline causing much larger problems along the pipeline.

### SUMMARY OF THE INVENTION

An object of the present invention is to solve the problem of effectively sealing problematic flanged connections such as water meters, ductile iron, epoxy coated, and stainless steel. It utilizes a non-metallic glass reinforced epoxy core and combines it with a kammprofile serration and sealing material placed on top of the serrations. It gives a superior non-metallic option for these problematic flanged connections which conventionally utilized only either a sheet gasket, which does not provide high quality sealing characteristics, or a metal gasket. Metal gaskets are, in some cases, not an option due to the load needed to seal them and/or potential corrosion issues when using metal gaskets.

In order to solve these limitations, the present invention provides a unique approach utilizing the above referenced glass reinforced epoxy gasket core material but we then machine a kammprofile serration pattern into the glass reinforced epoxy and then have the ability to utilize many different sealing materials on top of the kammprofile serrations. This results in a non-metallic gasket that can seal at low loads, high loads, and uneven loads—the primary issue that continues to plague many flanged connections.

### BRIEF DESCRIPTION OF THE DRAWINGS

FIG. 1 depicts a non-metallic gasket of some embodiments of the present invention having a substantially annular shape.

FIG. 2 depicts a non-metallic gasket of some embodiments of the present invention having an outer guide portion.

FIG. 3 depicts a non-metallic gasket of some embodiments of the present invention having a substantially annular shape.

FIG. 4 depicts a non-metallic gasket of some embodiments of the present invention having an outer guide portion.

### DETAILED DESCRIPTION

In the following description of embodiments of the present invention there are multiple details established to provide a thorough understanding of the disclosed embodiments. It should be clear that the description is not intended to limit the scope of the invention to these specific embodiments, and any variations, changes, substitutions, or equivalent components apparent to those skilled in the art should not be considered significant differences from the intended scope of the invention.

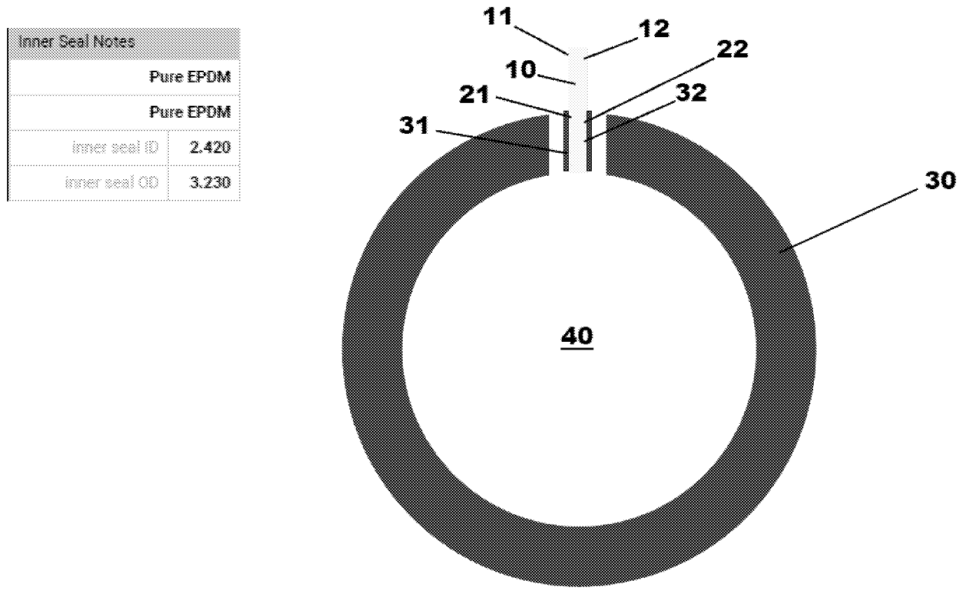

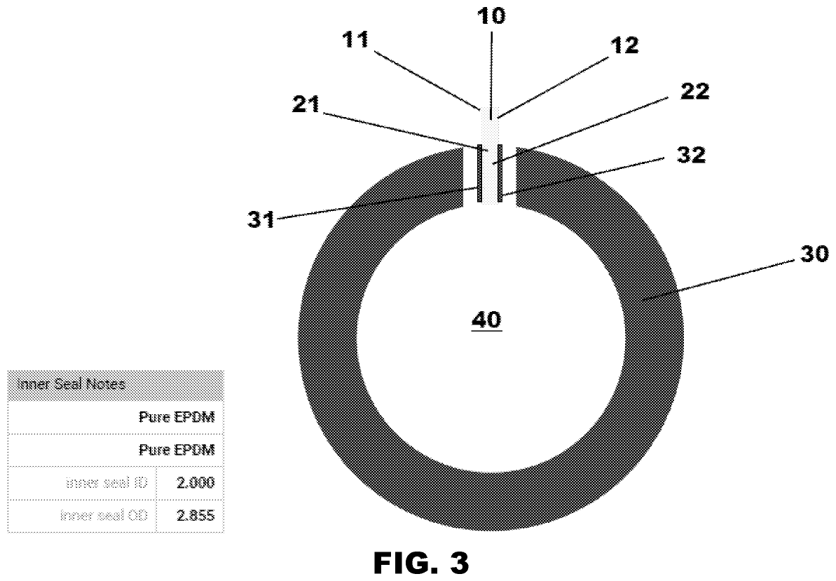

In some embodiments of the present invention, a non-metallic material is selected. This material may be, for example, a glass reinforced epoxy. As depicted in FIGS. 1 and 3, the material may be formed or shaped into a non-metallic gasket with a gasket core 10 having a substantially annular structure and configured with a central opening 40. The non-metallic gasket core may include a top face 11 and a bottom face 12. A kammprofile serration pattern may be machined into a primary sealing portion 21 of the top face 11. A corresponding kammprofile serration pattern may be machined into a corresponding primary sealing portion 22 of the bottom face 12. A sealing material 30 may then be applied to the gasket core. The sealing material is preferably deformable and soft. A first sealing material section 31 may be applied to the primary sealing portion 21 of the top face 11. A second sealing material section 32 may be applied to the primary sealing portion 22 of the bottom face 12.

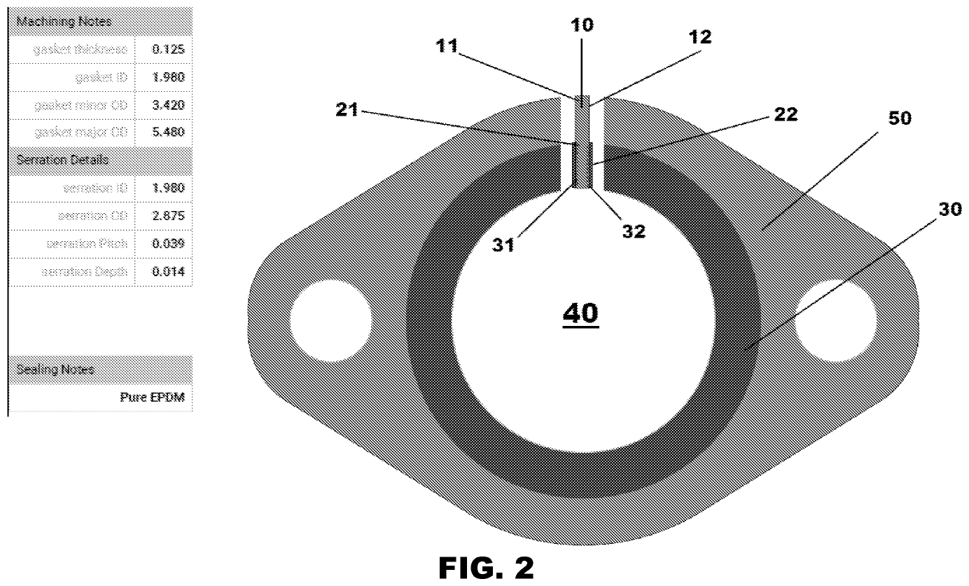

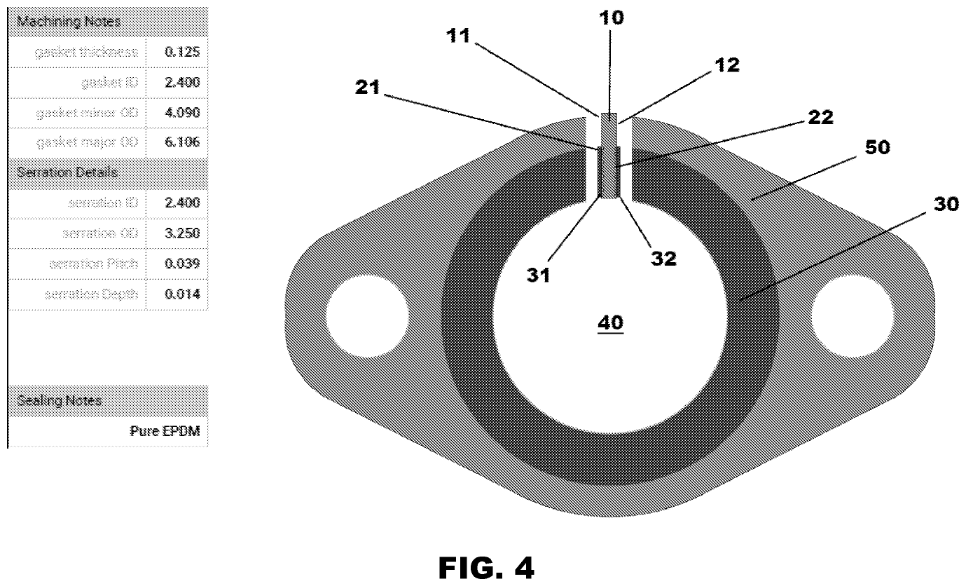

In other embodiments, such as that depicted in FIGS. 2 and 4, the non-metallic gasket may also have an outer guide portion 50. The outer guide portion 50 may be formed as part of the gasket core. In such embodiments, as depicted in FIGS. 2 and 4, the outer guide portion 50 is integral to the gasket core and is shaped to accommodate positioning of the substantially annular, central opening 40 relative a flanged or other connection.

In certain embodiments, the gasket core may have a thickness of greater than 0.1 in. and a preferable thickness of approximately 0.125 in. As depicted in FIGS. 1-4, the particular dimensions of the gasket (core, outer guide portion, and serrations) may vary depending on the particular design requirements or intended application of the gasket.

Through practice of these embodiments, anon-metallic gasket may be formed that does not creep or relax with pressure or temperature cycles. The gasket can achieve a seal at lower bolt loads than conventional metal kammprofile gaskets. The gasket also creates its own smaller loaded sealing area thereby allowing the same bolt load to apply more gasket seating stress to the seal. This gives it a tighter more reliable seal even at low bolt loads. The gasket also eliminates the potential for galvanic corrosion cells because it does not introduce metal to metal contact on the pipeline.

Overall, the gasket provides a unique solution for known problematic connections by utilizing a rigid, non-metallic gasket core material having a kammprofile serration pattern machined into the core. This allows for the ability to utilize many different sealing materials on top of the kammprofile serrations. This design takes advantage of the non-metallic core and the enhanced sealing potential created by the kammprofile serrations. The resulting non-metallic gasket can seal at low loads, high loads, and uneven loads. This is the primary issue that has continued to plague many flanged connections.

Despite conventional beliefs and understandings, the gasket embodiments described herein have successfully implemented kammprofile serrations with high points and low points into a GRE core. The high points create a series of points where the sealing element on top of the serrations gets more load applied to it and the soft sealing material on top of the serrations can also get deformed and pushed into the low points. This happens over and over again for every serration it the non-metallic core. The high points are what allow the gasket to gain a seal at low loads. The low points are what allow the gasket to seal at high loads. The combination of serrations and soft sealing material placed on top create a concentrated raised area which increases gaskets stress even at low loads thus allowing the gasket to seal at uneven loads.

1. A gasket for joining flanged connections comprising:
a gasket core composed of a non-metallic material, said gasket core comprising:
a first gasket portion having a top face with a top primary sealing area and a bottom face with a bottom primary sealing area, wherein said top primary sealing area is configured with a sealing geometry pattern and said bottom primary sealing area is configured with said sealing geometry pattern; and
a substantially central opening.

2. The gasket of claim 1 wherein said non-metallic material is glass reinforced epoxy.

3. The gasket of claim 2 further comprising a sealing material, wherein a first layer of said sealing material is disposed on said top primary sealing area and a second later of said sealing material is disposed on said bottom primary sealing area.

4. The gasket of claim 3 wherein said sealing geometry pattern is kammprofile serrations.

5. The gasket of claim 4 wherein said gasket core is substantially annular in shape.

6. The gasket of claim 5 wherein said sealing material is deformable.

7. The gasket of claim 1 wherein said gasket core further comprises an outer guide portion positioned exterior relative said first gasket portion.

8. The gasket of claim 7 wherein said non-metallic material is glass reinforced epoxy.

9. The gasket of claim 8 wherein said sealing geometry pattern is kammprofile serrations.

10. The gasket of claim 9 further comprising a sealing material, wherein a first layer of said sealing material is disposed on said top primary sealing area and a second later of said sealing material is disposed on said bottom primary sealing area.

11. The gasket of claim 10 wherein said sealing material is deformable.
